(19) United States
(12) Patent Application Publication
(10) Pub. No.: US 2014/0162925 A1
(43) Pub. Date: Jun. 12, 2014

(54) CLEANSING COMPOSITIONS AND PRODUCTS INCLUDING SOAP FLAKES AND METHODS FOR MAKING THE SAME

(71) Applicant: THE DIAL CORPORATION, Scottsdale, AZ (US)

(72) Inventors: Tasha Zander, Phoenix, AZ (US); Bin Lin, Scottsdale, AZ (US)

(73) Assignee: The Dial Corporation, Scottsdale, AZ (US)

(21) Appl. No.: 13/711,017

(22) Filed: Dec. 11, 2012

(51) Int. Cl. C11D 17/08

(52) U.S. Cl. CPC C11D 17/08
USPC 510/138; 510/418; 510/159; 510/293; 510/406

(57) ABSTRACT

Cleansing compositions, products, and methods for making cleansing products are provided herein. In one example, a cleansing composition comprises a liquid detergent or cleanser. Soap flakes are dispersed in the liquid detergent or cleanser.

### TECHNICAL FIELD

The present invention relates generally to cleansing products for fabrics, personal care, or the like, and more particularly relates to cleansing compositions including soap flakes dispersed in a liquid detergent or cleanser, cleansing products including such cleansing compositions, and methods for making such cleansing products.

### BACKGROUND

Liquid cleansing products such as liquid laundry detergents for cleaning fabrics and liquid body washes and soaps for personal care are well known products that have been used for many decades. Commercial markets for cleansing products are highly competitive with consumers wanting not only increased cleansing efficacy but other various effects including aesthetic appeal. Currently, some liquid laundry detergents, body washes, and soaps include carrier beads that come in various shapes, colors, and sizes. The carrier beads are dispersed in the liquid detergent or cleanser for aesthetic appeal. Additionally, these carrier beads provide an inert substrate that may be loaded with one or more ingredients, such as a fragrance, an active ingredient, or the like to functionally enhance the liquid detergent or cleanser. Unfortunately, the inert substrate itself provides little or no functional benefit, such as increasing cleansing efficacy, to the liquid cleansing product despite the incremental cost of adding the carrier beads to the liquid detergent or cleanser.

Accordingly, it is desirable to provide cleansing compositions that include a substantially fully functional and aesthetically appealing dispersion in a liquid detergent or cleanser, cleansing products including such cleansing compositions, and methods for making such cleansing products. Furthermore, other desirable features and characteristics of the present invention will become apparent from the subsequent detailed description and the appended claims, taken in conjunction with the accompanying drawings and this background.

### BRIEF SUMMARY

Cleansing compositions, products, and methods for making cleansing products are provided herein. In an exemplary embodiment, a cleansing composition comprises a liquid detergent or cleanser. Soap flakes are dispersed in the liquid detergent or cleanser.

In accordance with another exemplary embodiment, a cleansing product is provided. The cleansing product comprises a container and a cleansing composition that is housed within the container. The cleansing composition comprises a liquid detergent or cleanser and soap flakes that are dispersed in the liquid detergent or cleanser.

In accordance with another exemplary embodiment, a method for making a cleansing product is provided. The method comprises the steps of mixing detergent or cleanser ingredients together to form a liquid detergent or cleanser. Soap flakes are dispersed in the liquid detergent or cleanser to form a cleansing composition. The cleansing composition is deposited into a container.

### BRIEF DESCRIPTION OF THE DRAWINGS

The various embodiments will hereinafter be described in conjunction with the following drawing figures, wherein like numerals denote like elements, and wherein:

FIG. 1 is a tear-way perspective view of a cleansing product in accordance with an exemplary embodiment; and

FIG. 2 is a flowchart of a method for making a cleansing product in accordance with an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

The various embodiments contemplated herein relate to cleansing compositions and products, and methods for making cleansing products. Unlike the prior art, the exemplary embodiments taught herein provide a cleansing composition including soap flakes that are dispersed in a liquid detergent or cleanser. The soap flakes may be any shape(s), color(s), and/or size(s) for aesthetic appeal. In an exemplary embodiment, the soap flakes are substantially free of any fillers or inert carriers/substrates, and contains primarily active soap and optionally other active ingredients to provide a substantially fully functional dispersion in the liquid detergent or cleanser to enhance, for example, cleansing efficacy. As used herein, the term “substantially free” is understood to mean less than about 5 weight percent, such as from about 0 to about 3 weight percent, such as from about 0 to about 1 weight percent, for example about 0 weight percent, of the total composition. In an exemplary embodiment, the soap flakes break apart from friction and/or agitation during washing such as from clothes tumbling against each other in a wash machine to provide enhanced cleansing efficacy.

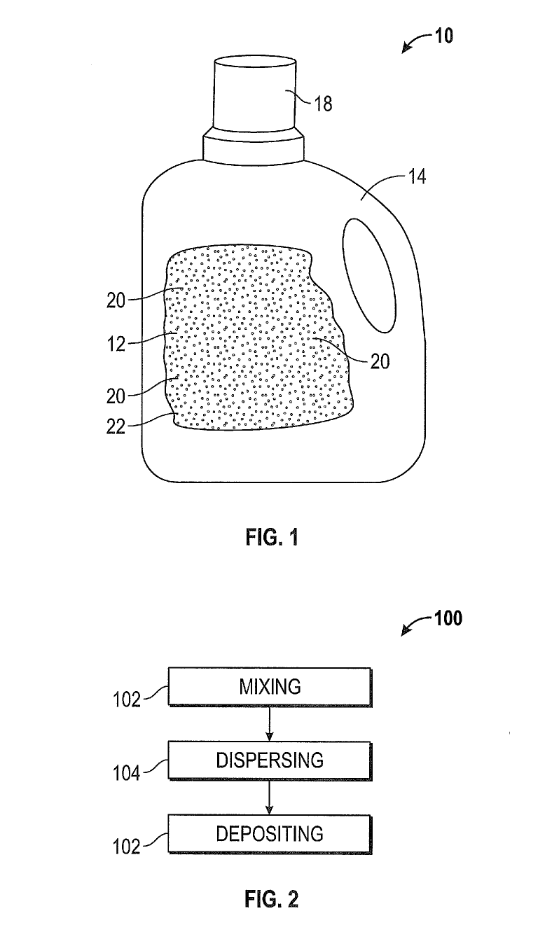

Referring to FIG. 1, a cleansing product 10 in accordance with an exemplary embodiment is provided. The cleansing product 10 comprises a cleansing composition 12, such as a liquid detergent, a liquid body wash, a liquid hand soap, or the like. The cleansing product 10 may also comprise a container 14 for containing and dispensing the cleansing composition 12. As illustrated, the container 14 comprises a container body 16 that contains the cleansing product 10 and a removable cap 18 that may be removed to allow the cleansing composition 12 to be dispensed (e.g., via pouring) from the container body 16.

The cleansing composition 12 contains soap flakes 20 that are dispersed as solid flakes in a liquid detergent or cleanser 22. In an exemplary embodiment, the soap flakes 20 are present in an amount of from about 0.5 to about 5 weight percent (wt. %), such as from about 0.75 to about 2 wt. %, of the cleansing composition 12. The soap flakes 20 may be any size(s), shape(s), or color(s) to impart a desired aesthetic appearance to the cleansing composition. Non-limiting examples of various shapes for the soap flakes 20 include stars, spheres, rods, shavings, leaves, diamonds, flowers, and the like. Non-limiting examples of various colors for the soap flakes 20 include white, blue, green, red, pink, red, orange, yellow, indigo, and the like. In an exemplary embodiment, the soap flakes have a thickness of from about 0.02 to about 3 mm.

In an exemplary embodiment, the soap flakes 20 comprise a solid form of active soap that may be derived, for example, by saponification (e.g., chemical reaction with lye (sodium hydroxide)) of oils, fats, or fatty acids from animal or vegetable sources as is well known in the art. The soaps employed may be prepared from packing house fats and greases, hydrogenated vegetable, fish or animal oils, tallow, lard, palm oil, castor oil, olive oil, coconut oil, and/or the like. Non-limiting examples of soaps include saturated fatty acid soaps, such as the salts (e.g., sodium, potassium or ammonium salts) of laurie acid, myristic acid, palmitic acid, stearic acid, hydrogenated erucic acid and behenic acid, and mixtures of soaps derived from natural fatty acids, e.g., coconut, palm kernel, or tallow fatty acids. In an exemplary embodiment, the soap is sodium stearate. Alternative active solid soaps known to those skilled in the art may also be used. In one embodiment, the soap flakes 20 comprise anhydrous active soap present in an amount of at least about 70 wt. %, such as from about 70 to about 95 wt. %, for example from about 70 to about 85 wt. %, of the total composition of the soap flakes 20.

Additionally, the soap flakes 20 may also include other active ingredients such as a nonionic synthetic detergent (e.g., alkyl-phenol-ether of a polyethylene glycol), anhydrous borax (i.e., tetraborate), perborate, organic calcium and magnesium sequestering agents (e.g., ethylene diame sodium tetra-acetate), and the like. In an exemplary embodiment, the soap flakes 20 comprise a nonionic synthetic detergent present in an amount of from about 5 to about 12 wt. %, and/or anhydrous borax present in an amount of from about 5 to about 18 wt % of the composition of the soap flakes 20. The soap flakes 20 may also contain a dye in a color determining effective amount.

The liquid detergent or cleanser 22 may be translucent or clear to allow the soap flakes 20 to be readily observed. In an exemplary embodiment, the liquid detergent or cleanser 22 is an aqueous-based mixture that comprises surfactant(s). In this regard, a variety of surfactants may be utilized.

In an exemplary embodiment, the liquid detergent or cleanser 22 comprises a nonionic surfactant. In one example, the liquid detergent or cleanser comprises the nonionic surfactant present in an amount of from about 1 to about 5 wt. % of the cleansing composition 12. Nonionic surfactants are particularly good at removing oily soils from fabrics. Nonionic surfactants that may be used in accordance with various embodiments include ethoxylated and/or propoxylated primary alcohols having 10 to 18 carbon atoms and on average from 4 to 10 moles of ethylene oxide (EO) and/or from 1 to 10 moles of propylene oxide (PO) per mole of alcohol. Further examples are alcohol ethoxylates containing linear radicals from alcohols of natural origin having 12 to 18 carbon atoms, e.g., from coconut, palm, tallow fatty or oleyl alcohol and on average from 2 to 8 EO per mole of alcohol.

In formulating the liquid detergent or cleanser 22, nonionic surfactants of the alcohol ethoxylate type are particularly useful since a proper HLB balance can be achieved between the hydrophobic and hydrophilic portions of the surfactant. It has been found that even though the preferred C₁₄-C₁₅ alcohol ethoxylate-7EO has a cloud point of about 115° F., it is stable in this detergent composition up to a temperature of about 140° F. A nonionic surfactant comprising a C₁₄-C₁₅ alcohol ethoxylate-7EO is available from Shell Chemical Co. under the trademark NEODOL 45-7.

Also, alkoxylated amines may be used as the nonionic surfactant component. Non-limiting examples include ethoxylated and/or propoxylated primary and secondary amines having 1 to 18 carbon atoms per alkyl chain and on average 1 to 12 moles of ethylene oxide (EO) and/or 1 to 10 moles of propylene oxide (PO) per mole of amine.

Other nonionic surfactants that may be used include alkylglycosides of the general formula RO(G)ₓ, where R is a primary straight-chain or methyl-branched (in the 2-position, for example) aliphatic radical having 8 to 22 carbon atoms and where G represents a glycosyl unit having 5 or 6 carbon atoms, for example glucose. The degree of oligomerization x, which indicates the distribution of monoglycosides and oligoglycosides, is any desired number from 1 to 10, such as x from 1.2 to 1.4.

Further useful nonionic surfactants include those known as gemini surfactants. This term is used generally to refer to those compounds that possess two hydrophilic and two hydrophobic groups per molecule. These groups are generally separated from one another by what is known as a spacer. This spacer is generally a carbon chain, which is normally long enough to keep the hydrophilic groups at a distance sufficient to allow them to act independently of one another. Surfactants of this kind are generally notable for an unusually low critical micelle concentration and the ability to markedly decrease the surface tension of water. Additionally, the term gemini surfactants is used to include not only dimeric but also trimeric surfactants.

Examples of useful gemini surfactants are sulfated hydroxy mixed ethers or dimer alcohol bis- and trimer alcohol tris-sulfates and ether sulfates. Tipped dimeric and trimeric mixed ethers are notable for their bi- and multi-functionality. These capped surfactants possess good wetting properties and are low-sudsing, making them particularly suitable for mechanical washing and cleaning processes. It is also possible to use gemini-polyhydroxy fatty acid amides or polyhydroxy fatty acid amides.

Further useful nonionic surfactants are polyhydroxy fatty acid amides of the formula;

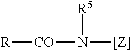

where R—CO is an aliphatic acyl radical having 6 to 22 carbon atoms, R⁵ is hydrogen or an alkyl or hydroxyalkyl radical having 1 to 4 carbon atoms, and [Z] is a linear or branched polyhydroxyalkyl radical having 3 to 10 carbon atoms and 3 to 10 hydroxyl groups. The polyhydroxy fatty acid amides are typically obtainable by reductive amination of a reducing sugar with ammonia, an alkylamine or an alkanolamine followed by subsequent acylation with a fatty acid, a fatty acid alkyl ester or a fatty acid chloride.

The group of the polyhydroxy fatty acid amides also includes compounds of the formula;

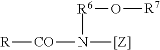

where R is a linear or branched alkyl or alkenyl radical having 7 to 12 carbon atoms, R⁶ is a linear, branched or cyclic alkyl radical or an aryl radical having 2 to 8 carbon atoms and R⁷ is a linear, branched or cyclic alkyl radical or an aryl radical or an oxyalkyl radical having 1 to 8 carbon atoms. For example, the substituents may include C₁₋₄-alkyl radicals or phenyl radicals, with [Z] being a linear polyhydroxyalkyl radical whose alkyl chain is substituted by at least two hydroxyl groups, or alkoxylated, preferably ethoxylated or propoxylated, derivatives of said radical.

Substituent [Z] may be obtained by reductive amination of a sugar such as glucose, fructose, maltose, lactose, galactose, mannose, or xylose. The N-alkoxy- or N-aryloxy-substituted compounds may then be converted to the target polyhydroxy fatty acid amides, by reaction with fatty acid methyl esters in the presence of an alkoxide as catalyst.

Amine oxides suitable in accordance with various embodiments include alkylamine oxides, in particular alkyldimethylamine oxides, alkylamidoamine oxides and alkoxyalkylamine oxides. Particularly useful amine oxides satisfy the formulas (I) and (II);

R⁶R⁷R⁸N⁺—O⁻ (I)

R⁶—[CO—NH—(CH₂)_{w}]_{z}—N⁺(R⁷)(R⁸)—O⁻ (II)

in which for both (I) and (II):
R⁶ is a saturated or unsaturated C₆₋₂₂-alkyl radical, such as C₈₋₁₈-alkyl radical, such as a saturated C₁₀₋₁₆-alkyl radical, for example a saturated C₁₂₋₁₄-alkyl radical, which is bonded to the nitrogen atom N in the alkylamidoamine oxides via a carbonylamidoalkylene group —CO—NH—(CH₂)_{z}, and in the alkoxyalkylamine oxides via an oxaalkylene group —O—(CH₂)_{z}, where z is in each case a number from 1 to 10, such as 2 to 5, for example 3, R⁷, R⁸ independently of one another are a C₁₋₄-alkyl radical, optionally hydroxy-substituted, e.g., a hydroxyethyl radical, such as a methyl radical.

Examples of suitable amine oxides are the following compounds named in accordance with INCI: Almondamidopropylamine Oxide, Babassuamidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C₈₋₁₀ Alkoxypropylamine Oxide, Dihydroxyethyl C₉₋₁₁ Alkoxypropylamine Oxide, Dihydroxyethyl C₁₂₋₁₅ Alkoxypropylamine Oxide-, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C₁₂₋₁₅ Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Oleamidopropylamine Oxide, Oleamine Oxide, Olivamidopropylamine Oxide, Palmitamidopropylamine Oxide, Palmitamine Oxide, PEG-3 Lauramine Oxide, Potassium Dihydroxyethyl Cocamine Oxide Phosphate, Potassium Tris phosphonomethylamine Oxide, Sesamidopropylamine Oxide, Soyamidopropylamine Oxide, Stearamidopropylamine Oxide, Stearamine Oxide, Tallowamidopropylamine Oxide, Tallowamine Oxide, Undecylenamidopropylamine Oxide and Wheat Germamidopropylamine Oxide.

In an exemplary embodiment, the liquid detergent or cleanser 22 comprises an anionic surfactant. In one example, the liquid detergent or cleanser 22 comprises the anionic surfactant present in an amount of from about 5 to about 10 wt. % of the cleansing composition 12. Various anionic surfactants may be used in accordance with the embodiments disclosed herein including, for example, the alkyl ether sulfates which are also known as alcohol ether sulfates. Alcohol ether sulfates are the sulfuric monoesters of the straight chain or branched C₇-C₂₁ alcohols ethoxylated with from about 0.5 to about 8 moles of ethylene oxide, such as C₁₂-C₁₈ alcohols containing from 0.5 to 8 EO. An anionic surfactant for use in one embodiment is C₁₂-C₁₈ alcohol ether sulfate with a degree of ethoxylation of from about 0.5 to about 8 ethylene oxide moieties.

Other anionic surfactants that can be used are alkyl sulfates, also known as alcohol sulfates. These surfactants have the general formula R—O—SO₃Na where R is from about 11 to 18 carbon atoms and may also be denoted as sulfuric monoesters of C₁₁-C₁₈ alcohols, examples being sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of the C₁₀-C₂₀ chain length which contain a synthetic straight-chain alkyl radical prepared on a petrochemical basis, these sulfates possessing degradation properties similar to those of the corresponding compounds based on fatty-chemical raw materials. From a detergents standpoint, C₁₂-C₁₆-alkyl sulfates and C₁₂-C₁₅-alkyl sulfates, and also C₁₄-C₁₅ alkyl sulfates, are particularly useful. In addition, 2,3-alkyl sulfates, which may for example be obtained as commercial products from Shell Oil Company under the name DAN®, are suitable anionic surfactants.

Other anionic surfactants that are useful in the liquid detergent or cleanser 22 are the alkyl benzene sulfonates. Suitable alkyl benzene sulfonates include the sodium salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, functioning as precursors to the alkyl benzene sulfonates useful for compositions herein, are those in which the alkyl chain is linear and averages about 8 to 16 carbon atoms (C₈-C₁₆) in length. Examples of commercially available alkyl benzene sulfonic acids useful in the liquid detergent or cleanser 22 include Calsoft LAS-99 marketed by the Pilot Chemical Company.

Further useful anionic surfactants include additional sulfonate type and sulfate type surfactants. Examples of useful sulfonate type surfactants are olefinsulfonates, i.e., mixtures of alkenesulfonates and hydroxyalkanesulfonates, and also disulfonates as are obtained, for example, from C₁₂₋₁₈-monoolefins having a terminal or internal double bond by sulfonating with gaseous sulfur trioxide followed by alkaline or acidic hydrolysis of the sulfonation products. Also suitable are alkanesulfonates, which are obtained from C₁₂₋₁₈-alkanes, for example by sulfochlorination or sulfoxidation with subsequent hydrolysis or neutralization, respectively. Likewise suitable, in addition, are the esters of α-sulfo fatty acids (ester sulfonates), e.g., the α-sulfonated methyl esters of hydrogenated coconut, palm kernel or tallow fatty acids.

Further suitable anionic surfactants are sulfated fatty acid glycerol esters which are the monoesters, diesters and triesters, and mixtures thereof, as obtained in the preparation by esterification of a monoglycerol with from 1 to 3 moles of fatty acid or in the transesterification of triglycerides with from 0.3 to 2 moles of glycerol. Preferred sulfated fatty acid glyceryl esters are sulfation products of saturated fatty acids of 6 to 22 carbon atoms, e.g., of capric acid, caprylic acid, capric acid, myristic acid, lauric acid, palmitic acid, stearic acid or behenic acid.

Further anionic surfactants for use in the liquid detergent or cleanser 22 also include the salts of alkylsulfosuccinic acid, which are also referred to as sulfosuccinates or as sulfosuccinic esters and which constitute the monoesters and/or diesters of sulfosuccinic acid with alcohols, for example fatty alcohols and ethoxylated fatty alcohols. Exemplary sulfosuccinates comprise C₈₋₁₈ fatty alcohol radicals or mixtures thereof. Exemplary sulfosuccinates contain a fatty alcohol radical derived from ethoxylated fatty alcohols which themselves represent nonionic surfactants. Of use in the liquid detergent or cleanser 22 are the sulfosuccinates whose fatty alcohol radicals are derived from ethoxylated fatty alcohols having a narrowed homolog distribution. Similarly, it is also possible to use alk(en)ylsuccinic acid containing 8 to 18 carbon atoms in the alk(en)yl chain, or salts thereof.

Further suitable anionic surfactants are conventional soaps. Suitable soaps include saturated fatty acid soaps, such as the salts of lauric acid, myristic acid, palmitic acid, stearic acid, hydrogenated erucic acid and behenic acid, and mixtures of soaps derived from natural fatty acids, e.g., coconut, palm kernel, or tallow fatty acids. The anionic surfactants, including the soaps, may be present in the form of their sodium, potassium or ammonium salts and also as soluble salts of organic bases, such as mono-, di- or triethanolamine.

A further class of anionic surfactants is the class of ether carboxylic acids that are obtainable by reacting fatty alcohol ethoxylates with sodium chloroacetate in the presence of basic catalysts. Ether carboxylic acids have the general formula: R¹⁰O—(CH₂—CH₂—O)ₚ—CH₂—COOH where R¹⁰ is C₁-C₁₈ and p is 0.1 to 20. Ether carboxylic acids are water hardness insensitive and have excellent surfactant properties.

Additional Additives.

The liquid detergent or cleanser 22 may further comprise one or more other conventional additives such as a cationic and amphoteric surfactants, an optical brightener, a coloring agent, a fragrance, an enzyme, a builder, an electrolyte, a UV absorber, a bleach, a chelating agent, a preservative, a redeposition inhibitor, a dye transfer inhibitor, a thickener and/or a suspending agent, a crease control agent, a pearl luster agent, a fabric softener, and/or mixtures thereof. One or more of such additives may be present in any amount suitable to achieve a particular objective. In an exemplary embodiment, these additives, alone or combined, are not present in an amount that is greater than about 12 wt. % of the cleansing composition 12. However, any effective amount of additional additives, alone or combined may be utilized in accordance with various embodiments insofar as such additives do not detrimentally affect the desired properties of the cleansing composition 12.

Cationic Surfactants.

In an exemplary embodiment, cationic surfactants may be added to the liquid detergent or cleanser 22. Cationic surfactants are any agent that functions as detergency booster. If cationic surfactants are used, they are present in the liquid detergent or cleanser 22 in relatively small quantities on the order of from about 0.01 to about 10 wt. %, such as from about 0.1 to about 3.0 wt. %, of the cleansing composition 12.

Amphoteric Surfactants.

Optionally, the liquid detergent or cleanser 22 may additionally comprise amphoteric surfactants. Amphoteric surfactants may be present in an amount of from about 0.5 to about 5 wt. % of the cleansing composition 12. Particularly useful amphoteric surfactants are the alkylbetaines of the formula (Ia), the alkylamidobetaines of the formula (Ib), the sulfobetaines of the formula (Ic) and the amidosulfobetaines of the formula (Id),

R¹—N₊(CH₃)₂—CH₂COO— (Ia)

R¹—CO—NH—(CH₂)₃—N⁺(CH₃)₂—CH₂COO— (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹ is a saturated or unsaturated C₆₋₂₂-alkyl radical, such as C₈₋₁₈-alkyl radical, such as a saturated C₁₀₋₁₆-alkyl radical, for example a saturated C₁₂₋₁₄-alkyl radical. Other useful amphoteric surfactants are the carbobetaines, in particular the carbobetaines of the formula (Ia) and (Ib), most preferably the alkylamidobetaines of the formula (Ib).

Examples of suitable betaines and sulfobetaines are the following compounds named according to INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kemelamiodopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. Other amphoteric surfactants known to those skilled in the art may also be employed.

Optical Brighteners.

In an exemplary embodiment, the liquid detergent or cleanser 22 comprises an optical brightener (so-called “whitening agent”) component present in an amount of from about 0.01 to about 1 wt. % of the cleansing composition 12. The optical brightener agent can comprise virtually any brightener that is capable of eliminating graying and yellowing of fabrics. Typically, these substances attach to the fibers and bring about a brightening and simulated bleaching action by converting invisible ultraviolet radiation into visible longer-wave length light, the ultraviolet light absorbed from sunlight being irradiated as a pale bluish fluorescence and, together with the yellow shade of the grayed or yellowed laundry, producing pure white. Additional optical brighteners useful in accordance with various exemplary embodiments include, but are not limited to, the classes of substance of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazol, benzisoxazol and benzimidazol systems, and pyrene derivatives substituted by heterocycles, and the like.

Coloring Agents.

In accordance with another exemplary embodiment, coloring agents and dyes, especially bluing agents, may be added to increase aesthetic appeal and consumer performance impression of the cleansing composition 12. When present, such coloring agents and/or dyes are used at very low levels such as from about 0.0001 to 0.01 wt. % of the cleansing composition 12, to avoid staining or marking surfaces on which the cleansing composition 12 may be used, such as on fabrics.

A wide variety of coloring agents and dyes are well known and suitable for use with the various embodiments described herein. Some non-limiting examples of dyes that are commercially available from Milliken are, Liquitint Blue HP®, Liquitint Blue 65®, Liquitint Patent Blue®, Liquitint Royal Blue®, Liquitint Experimental Yellow 8949-43®, Liquitint Green HMC®, Liquitint Yellow II®, and mixtures thereof, preferably Liquitint Blue HP®, Liquitint Blue 65®, Liquitint Patent Blue®, Liquitint Royal Blue®, Liquitint Experimental Yellow 8949-43®, and mixtures thereof.

Fragrances.

The liquid detergent or cleanser 22 may also comprise a fragrance component. In an exemplary embodiment, the fragrance component is present in an amount of from about 0 to about 1 wt. % of the cleansing composition 12. The fragrance component may comprise any agent that is capable of covering the chemical odor of the cleansing composition 12 and the odor of soils in the washing solution, imparting a pleasant scent to fabrics, and/or contributing an identifying scent to the cleansing product 10. Additionally, a variety of fragrance components are available that employ any number of malodor-neutralizing mechanisms; in addition, malodor covering agents are suitable for use in connection with the various embodiments disclosed herein.

Useful fragrance components are known in the art and are available from any number of sources. For example, the cleansing composition 12 may comprise a Mountain Breeze scent, which is commercially available from the Lebermuth Company located in South Bend, Ind. However, it will be appreciated that any known or hereafter devised scent, such as for example, baby powder or lemon may alternatively be used.

Enzymes.

The liquid detergent or cleanser 22 may also comprise enzymes. The enzyme may comprise any agent that aids in breaking down complex soils, especially proteins such as grass and blood, so that these soils can be more easily removed by other detergent ingredients. Enzymes may be formed into shaped articles and adsorbed on carriers or embedded in coatings and thus be protected against premature decomposition. The amount of enzyme(s) may be present in an amount of from about 0.01 to about 5 wt. %, such as from about 0.12 to about 2.5 wt. %, of the cleansing composition 12.

Useful enzymes include, but are not limited to, the class of the hydrolases such as the proteases, esterases, lipases or lipolytically acting enzymes, amylases, cellulases or other glycosyl hydrolases, hemicellulases, cutinases, .beta.-glucanases, oxidases, peroxidases, perhydrolases or laccases and mixtures thereof. All these hydrolases contribute in the wash to the removal of stains such as proteinaceous, greasy or starchy stains and grayness. Cellulases and other glycosyl hydrolases may in addition, through the removal of pilling and microfibrils, contribute to textile color preservation and softness enhancement. Similarly, oxyreductases can be used for bleaching or for inhibiting dye transfer. Enzymatic actives obtained from bacterial strains or fungi such as Bacillus subtilis, Bacillus licheniformis, Streptomyceus griseus and Humicola insolens are particularly useful. Particularly useful is proteases of the subtilisin type and especially proteases obtained from Bacillus lentus. Enzyme mixtures, for example of protease and amylase or of protease and lipase or lipolytically acting enzymes or of protease and cellulase or of cellulase and lipase or lipolytically acting enzymes or of protease, amylase and lipase or of lipolytically acting enzymes or protease, lipase or lipolytically acting enzymes and cellulase, but especially protease and/or lipase-containing mixtures or mixtures with lipolytically acting enzymes are of particular interest. The familiar cutinases are examples of such lipolytically acting enzymes. Similarly, peroxidases or oxidases will be found useful in some cases. Useful amylases include especially α-amylases, isoamylases, pullulanases and pectinases. Cellulases used are preferably cellobiohydrolases, endoglucanases and β-glucosidases, also known as cellobiases, and mixtures thereof. Since the various cellulase types differ in CMCase and Avicelase activity, desired activities can be achieved through specific mixtures of the cellulases.

Builders.

Optionally, the liquid detergent or cleanser 22 may comprise builders. As is known in the art, water hardness ions may interact with negatively charged surfactants and inhibit soil removal and decreasing the overall efficiency of the surfactant system. As such, it may be desirable to include a builder to soften water by tying up water hardness, to prevent redeposition of soils, and to provide a desirable level of alkalinity, which aids in cleaning. In an exemplary embodiment, the liquid detergent or cleanser 22 comprises builders in amounts of from about 1 to about 5 wt. % of the cleansing composition 12.

Any builder customarily used in cleansing compositions may be incorporated in the liquid detergent or cleanser 22, including zeolites, silicates, carbonates, organic cobuilders and, where there are no ecological prejudices against their use, phosphates.

In one embodiment, a precipitating builder, such as sodium carbonate or sodium silicate is used to remove water hardness ions by forming an insoluble substance or precipitant. Addition of a builder such as sodium carbonate is especially useful when the water hardness is due to calcium ions.

Useful crystalline, sheet-shaped sodium silicates have the general formula NaMSiₓO₂.x+1H₂O, where M is sodium or hydrogen, x is from 1.9 to 4, y is from 0 to 20 and x is preferably 2, 3 or 4. Particularly useful are crystalline sheet silicates of the stated formula in which M is sodium and x is 2 or 3. In particular, not only β- but also δ-sodium disilicates Na₂Si₂O₅.yH₂O may be used.

In an exemplary embodiment, the finely crystalline synthetic zeolite, containing bound water, may be used such as zeolite A and/or P. Also suitable are zeolite X, and mixtures of A, X and/or P. In one example, useful zeolites have an average particle size of less than 10 μm (volume distribution; method of measurement: Coulter Counter) and have a bound-water content which is from about 18 to about 22 wt. %. The zeolites can also be used as over-dried zeolites having lower water contents and then are by virtue of their hygroscopicity useful to remove unwanted trace residues of free water.

It will be appreciated that the well-known phosphates can likewise be used as builder substances, unless such a use is to be avoided for ecological reasons. Useful phosphates include in particular the sodium salts of the orthophosphates, of the pyrophosphates, and especially of the tripolyphosphates.

Organic builder substances useful as cobuilders and also as viscosity regulators include for example the polycarboxylic acids which can be used in the form of their sodium salts, polycarboxylic acids referring to carboxylic acids having more than one acid function. Examples thereof are citric acid, adipic acid, succinic acid, glutaric acid, malic acid, tartaric acid, maleic acid, fumaric acid, sugar acids, amino carboxylic acids, nitrilotriacetic acid (NTA) and derivatives thereof and also mixtures of these. Salts of polycarboxylic acids such as citric acid, adipic acid, succinic acid, glutaric acid, tartaric acid, sugar acids and mixtures of these may also be used.

The acids themselves can be used as well. As well as their builder action, the acids typically also have the property of an acidifying component and thus also serve to impart a lower and milder pH to the cleansing composition 12. Particularly used for this are citric acid, succinic acid, glutaric acid, adipic acid, gluconic acid and any desired mixtures of these. Useful acidifying agents further include known pH regulators such as sodium bicarbonate and sodium hydrogensulfate.

Useful builders further include polymeric poly carboxylates, i.e., for example the alkali metal salts of polyacrylic acid or of polymethacrylic acid, for example those having a relative molecular mass in the range from 500 to 70,000 g/mole. Useful polymers are in particular polyacrylates which can have a molecular mass of from about 2000 to about 20,000 g/mole. Owing to their superior solubility, preference in this group may be given in turn to the short-chain polyacrylates which have molar masses of from about 2000 to about 10,000 g/mol, such as from about 3000 to about 5000 g/mole. Useful polymers may further include substances which partly or wholly consist of units of vinyl alcohol or its derivatives.

Useful polymeric polycarboxylates further include copolymeric polycarboxylates, especially those of acrylic acid with methacrylic acid and of acrylic acid or methacrylic acid with maleic acid. Of particular usefulness are copolymers of acrylic acid with maleic acid which comprise from about 50 to about 90 wt. % of acrylic acid and from about 10 to about 50 wt. % of maleic acid. Their relative molecular mass based on free acids is generally from about 2000 to about 70,000 g/mole, such as from about 20,000 to about 50,000 g/mol, for example from about 30,000 to about 40,000 g/mole. (Co)polymeric polycarboxylates can be used either as an aqueuous solution or as a powder.

To improve solubility in water, polymers may further comprise allylsulfonic acids, such as allyloxybenzenesulfonic acid and methallylsulfonic acid, as a monomer. Also, biodegradable polymers may be used that are composed of more than two different monomer units, for example those that comprise salts of acrylic acid and of maleic acid and also vinyl alcohol or vinyl alcohol derivatives as monomers or comprise salts of acrylic acid and of 2-alkylallylsulfonic acid and also sugar derivatives as monomers. Some non-limiting examples of useful copolymers include those that as monomers comprise acrolein and acrylic acid/acrylic acid salts or acrolein and vinyl acetate.

Builder substances further include polymeric amino dicarboxylic acids, their salts or their precursor substances. Particularly, polyaspartic acids or salts and derivatives thereof may be useful, of which it is known that they have a bleach-stabilizing effect as well as cobuilder properties. It is further possible to use polyvinylpyrrolidones, polyamine derivatives such as quaternized and/or ethoxylated hexamethylenediamines.

Useful builder substances further include polyacetals that can be obtained by reacting dialdehydes with polycarboxylic acids having 5 to 7 carbon atoms and 3 or more hydroxyl groups. Preferred polyacetals are obtained from dialdehydes such as glyoxal, glutaraldehyde, terephthalaldehyde and mixtures thereof and from polycarboxylic acids such as gluconic acid and/or glucoheptonic acid.

Useful organic builder substances further include dextrins, for example oligomers or polymers of carbohydrates obtainable by partial hydrolysis of starches. The hydrolysis can be carried out by customary, for example acid- or enzyme-catalyzed, processes. The hydrolysis products preferably have average molar masses of from about 400 to about 500,000 g/mole. Preference here may be given to a polysaccharide having a dextrose equivalent (DE) of from about 0.5 to about 40, such as from about 2 to about 30, DE being a common measure of the reducing effect of a polysaccharide compared with dextrose, which has a DE of 100. It is also possible to use maltodextrins having a DE from about 3 to about 10 and dried glucose syrups having a DE from about 20 to about 37, and also so-called yellow dextrins and white dextrins having relatively higher molar masses of from about 2000 to about 30,000 g/mole.

The oxidized derivatives of such dextrins are their reaction products with oxidizing agents that are able to oxidize at least one alcohol function of the saccharide ring to the carboxylic acid function. It is likewise possible to use an oxidized oligosaccharide. A product oxidized on the C₆ of the saccharide ring may be particularly advantageous.

Useful cobuilders further include oxydisuccinates and other derivatives of disuccinates, preferably ethylenediaminedisuccinate. Here, ethylenediamine-N,N′-disuccinate (EDDS), is used in the form of its sodium or magnesium salts. Also in this connection are glycerol disuccinates and glycerol trisuccinates. Suitable use levels in zeolite-containing and/or silicate-containing formulations are from about 3 to about 15 wt. %.

Useful organic cobuilders further include for example acetylated hydroxycarboxylic acids and salts thereof. These, if desired, may also be present in lactone form and comprise at least 4 carbon atoms and at least one hydroxyl group and also not more than two acid groups.

Electrolytes.

Optionally, the liquid detergent or cleanser 22 may comprise electrolytes. A large number of various salts can be used as electrolytes from the group of the inorganic salts. Particularly useful cations are the alkali and alkaline earth metals and particularly useful anions are the halides and sulfates. From the point of view of manufacturing convenience, NaCl or MgCl₂ may be used in the liquid detergent or cleanser 22. In an exemplary embodiment, the amount of electrolytes in the liquid detergent or cleanser 22 is from about 0.5 to about 5 wt. % of the cleansing composition 12.

UV Absorbers.

The liquid detergent or cleanser 22 may further comprise UV absorbers. UV absorbers may comprise any agent which improves the light stability of the fibers and/or the light stability of the other formula components. UV absorbers should be understood to mean organic substances (light filters) which are capable of absorbing ultraviolet rays and reemitting the absorbed energy in the form of longer-wave radiation, e.g., heat. UV absorbers are typically used in amounts of from about 0.01 to about 5 wt. % of the cleansing composition 12.

Examples of compounds which have these desired properties include, but are not limited to, the compounds active through non-radiative deactivation and derivatives of benzophenone with substituents in the 2- and/or 4-position. Further, substituted benzotriazoles, such as for example the water-soluble benzenesulfonic acid-3-(2H-benzotriazol-2-yl)-4-hydroxy-5-(methylpropyl)-monosodium salt (Cibafast® H), acrylates phenyl-substituted in the 3-position (cinnamic acid derivatives), optionally with cyano groups in the 2-position, salicylates, organic Ni complexes and natural substances such as umbelliferone and the endogenous urocanic acid are suitable. Of particular importance are biphenyl derivatives and, above all, stilbene derivatives.

As UV-B absorbers, mention can be made of 3-benzylidenecamphor and 3-benzylidene-norcamphor and derivatives thereof, e.g., 3-(4-methylbenzylidene)camphor, 4-aminobenzoic acid derivatives, preferably 4-(dimethylamino)benzoic acid 2-ethylhexyl ester, 4-(dimethylamino)benzoic acid 2-octyl ester and 4-(dimethylamino)benzoic acid amyl ester, esters of cinnamic acid, preferably 4-methoxycinnamic acid 2-ethylhexyl ester, 4-methoxycinnamic acid propyl ester, 4-methoxycinnamic acid isoamyl ester and 2-cyano-3,3-phenylcinnamic acid 2-ethylhexyl ester (Octocrylene), esters of salicylic acid, preferably salicylic acid 2-ethylhexyl ester, salicylic acid 4-isopropylbenzyl ester and salicylic acid homomenthyl ester, derivatives of benzophenone, preferably 2-hydroxy-4-methoxybenzophenone, 2-hydroxy-4-methoxy-4′-methylbenzophenone and 2,2′-dihydroxy-4-methoxybenzophenone, esters of benzalmalonic acid, preferably 4-methoxybenzmalonic acid di-2-ethylhexyl ester, triazine derivatives such as for example 2,4,6-trianilino-(p-carbo-2′-ethyl-1′-hexyloxy)-1,3,5-triazine and octyl triazone, or dioctyl butamido triazone (Uvasorbg HEB), propane-1,3-diones such as for example 1-(4-tert-butylphenyl)-3-(4′-methoxyphenyl)propane-1,3-dione and ketotricyclo-(5.2.1.0)decane derivatives. Also suitable are 2-phenylbenzimidazole-5-sulfonic acid and alkali metal, alkaline earth metal, ammonium, alkylammonium, alkanolammonium and glucammonium salts thereof, sulfonic acid derivatives of benzophenones, preferably 2-hydroxy-4-methoxybenzophenone-5-sulfonic acid and salts thereof, sulfonic acid derivatives of 3-benzylidenecamphor, such as for example 4-(2-oxo-3-bomylidenemethyl)benzenesulfonic acid and 2-methyl-5-(2-oxo-3-bornylidene)sulfonic acid and salts thereof.

Typical UV-A filters are in particular derivatives of benzoylmethane, such as for example 1-(4′-tert-butyl-phenyl)-3-(4′-methoxyphenyl)propane-1,3-dione, 4-tert-butyl-4′-methoxydibenzoylmethane (Parsol 1789), 1-phenyl-3-(4′-isopropylphenyl)-propane-1,3-dione and also enamine compounds. The UV-A and UV-B filters can of course also be used as mixtures. In addition to the stated soluble substances, insoluble light-protective pigments, that is finely dispersed preferably nanoized metal oxides or salts, are also possible for this. Examples of suitable metal oxides are in particular zinc oxide and titanium dioxide and also oxides of iron, zirconium, silicon, manganese, aluminum and cerium and also mixtures thereof. As salts, silicates (talc), barium sulfate or zinc stearate can be used. The oxides and salts are already used in the form of the pigments for skincare and skin protection emulsions and decorative cosmetics. The particles here should have a mean diameter of less than about 100 nm, such as from about 5 to about 50 nm, for example from about 15 to about 30 nm. They can be spherical in shape, but particles having an ellipsoidal shape or a shape deviating in other ways from the spherical form can also be used. The pigments can also be surface-treated, i.e., hydrophobized or hydrophilized. Typical examples are coated titanium dioxides, such as for example titanium dioxide T 805 (Degussa) or Eusolex® T2000 (Merck). Possible hydrophobic coating agents here are above all silicones and specifically trialkoxyoctylsilanes or simethicones.

Bleach Agent.

The liquid detergent or cleanser 22 may further comprise a bleaching agent. Various bleaching agents are known in the art and include any agent which makes the fabric whiter or lighter especially by physical or chemical removal of color. In an exemplary embodiment, the amount of bleaching agent present is from about 0.5% to about 10 wt. % of the cleansing composition 12.

Among compounds that serve as bleaches in that they liberate H₂O₂ in water, are sodium percarbonate, sodium perborate tetrahydrate, sodium perborate monohydrate. Useful bleaches further include for example peroxypyrophosphates, citrate perhydrates and also H₂O₂-supplying peracidic salts or peracids, such persulfates and persulfuric acid. It is also possible to use urea peroxohydrate, i.e., percarbamide, which is described by the formula H₂N—CO—NH₂.H₂O₂. Especially when the compositions are used for cleaning hard surfaces, for example in dishwashers, they can if desired also include bleaches from the group of organic bleaches, although their use is in principle also possible in textile-washing compositions. Typical organic bleaches include diacyl peroxides, for example dibenzoyl peroxide. Typical organic bleaches further include peroxyacids, examples being in particular alkylperoxyacids and arylperoxy-acids. Preferred representatives are peroxybenzoic acid and its ring-substituted derivatives, such as alkylperoxybenzoic acids, but also peroxy-.alpha.-naphthoic acid and magnesium monoperphthalate, aliphatic or substitutedly aliphatic peroxyacids, such as peroxylauric acid, peroxystearic acid, .epsilon.-phthalimidoperoxycaproic acid (phthalimidoperoxyhexanoic acid, PAP), o-carboxybenzamidoperoxycaproic acid, N-nonenylamidoperadipic acid and N-nonenylamidopersuccinates, and alipahtic and araliphatic peroxydicarboxylic acids, such as 1,12-diperoxy carboxylic acid, 1,9-diperoxyazelaic acid, diperoxysebacic acid, diperoxybrassylic acid, diperoxyphthalic acids, 2-decyldiperoxybutane-1,4-diacid, N,N-terephthaloyldi(6-aminopercaproic acid).

The liquid detergent or cleanser 22 may further comprise bleach activators. Compounds used as bleach activators produce aliphatic peroxo carboxylic acids having preferably 1 to 10 carbon atoms and especially 2 to 4 carbon atoms and/or as the case may be substituted perbenzoic acid under perhydrolysis conditions. Substances that bear 0- and/or N-acyl groups of the stated number of carbon atoms and/or substituted or unsubstituted benzoyl groups are suitable. Preference is given to multiply acylated alkylenediamines, especially tetraacetylethylenediamine (TAED), acylated triazine derivatives, especially 1,5-diacetyl-2,4-dioxohexahydro-1,3,5-tri-azine (DADHT), acylated glycolurils, especially tetraacetylglycoluril (TAGU), N-acylimides, especially N-nonanoylsuccinimide (NOSI), acylated phenolsulfonates, especially n-nonanoyl- or isononanoyloxybenzenesulfonate (n- and iso-NOBS respectively), carboxylic anhydrides, especially phthalic anhydride, acylated polyhydric alcohols, especially triacetin, triethyl acetylcitrate (TEAC), ethylene glycol diacetate, 2,5-diacetoxy-2,5-dihydrofuran and the enol esters and also acetylated sorbitol and mannitol or to be more precise their SORMAN mixtures, acylated sugar derivatives, especially pentaacetylglucose (PAG), pentaacetylfructose, tetraacetylxylose and octaacetyllactose and also acylated, optionally N-alkylated glucamine and gluconolactone, and/or N-acylated lactams, for example N-benzoylcaprolactam. The hydrophilically substituted aceylacetals and the acyllactams are likewise preferred. Similarly, the combinations of conventional bleach activators can likewise be used.

Chelating Agents.

The liquid detergent or cleanser 22 may also comprise a chelating agent(s). Chelating agents may include any agents used to deactivate hard water minerals such as calcium and magnesium and to reduce the effects of other dissolved metals such as manganese.

In an exemplary embodiment, the chelating agents are present in an amount of from about 0.001 to about 5 wt. %, such as from about 0.001 to 1 wt. %, for example from about 0.001 to 0.5 wt. %, of the cleansing composition 12.

In one embodiment, ethylenediaminetetraacetic acid (EDTA) is used as the chelating agent. Other chelants that may be used can be selected from the group consisting of amino carboxylates, amino phosphonates, polyfunctionally-substituted aromatic chelating agents and mixtures thereof, all as hereinafter defined and all preferably in their acidic form. Amino carboxylates useful as chelating agents herein include ethylenediaminetetraacetic acid (EDTA), N-hydroxyethylethylenediaminetriacetates, nitrilotriacetates (NTA), ethylenediamine tetraproprionates, ethylenediamine-N,N′-diglutamates, 2-hydroxypropylenediamine-N,N′-disuccinates, triethylenetetraaminehexacetates, diethylenetriaminepentacetates (DTPA) and ethanoldiglycines, including their water-soluble salts such as the alkali metal, ammonium, and substituted ammonium salts thereof and mixtures thereof.

Preservative.

Optionally, a solubilized preservative may be added to the liquid detergent or cleanser 22. In an exemplary embodiment, the level of preservative, when present, is from about 0.01 to about 0.5 wt. %, such as from about 0.02 to about 0.2 wt. %, for example from about 0.05 to about 0.1 wt. %, of the cleansing composition 12.

In an exemplary embodiment, a preservative that is effective to inhibit and/or control both bacteria and fungi is used. In one example, an effective amount of Dantogard® preservative, available from Lonza Group of Switzerland, is utilized. Additional suitable preservatives may include any organic preservative that will not adversely affect or damage fabric articles. In an exemplary embodiment, the water-soluble preservatives include, for example, halogenated compounds, hydantoin compounds, organic sulfur compounds, low molecular weight aldehydes, benzalkonium chlorides, alkylaryl-sulfonates, halophenols, cyclic organic nitrogen compounds, quaternary compounds, dehydroacetic acid, phenyl and phenoxy compounds.

Redeposition Inhibitor.

A redeposition inhibitor (“grayness inhibitor”) may also be added to the liquid detergent or cleanser 22. Typically, the amount of these redeposition inhibitors does not exceed about 2 wt. % of the cleansing composition 12. Redeposition inhibitors are any agent designed to keep the soil detached from the fiber suspended in the liquor and to prevent its redeposition on the fiber.

Useful redeposition inhibitors may include water-soluble colloids mostly organic in nature, for example glue, gelatin, salts of ether sulfonic acids of starch or of cellulose or salts of acidic sulfuric esters of cellulose or of starch. Similarly, water-soluble polyamides which comprise acidic groups are suitable for this purpose. It is also possible to use soluble starch preparations and starch products other than those mentioned above, for example degraded starch, aldehyde starches, etc. Polyvinylpyrrolidone can be used as well. However, preference is given to cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose.

Suitable anti-redeposition agents, which are also referred to as soil repellants, also include, for example, nonionic cellulose ethers, such as methylcellulose and methylhydroxypropylcellulose with a content of methoxy groups of from 15 to 30% by weight and of hydroxypropyl groups of from 1 to 15% by weight, in each case based on the nonionic cellulose ethers, and the polymers, known from the prior art, of phthalic acid and/or terephthalic acid or derivatives thereof, in particular polymers of ethylene terephthalates and/or polyethylene glycol terephthalates or anionically and/or nonionically modified derivatives of these. Of these, particular preference is given to the sulfonated derivatives of phthalic acid and terephthalic acid polymers.

Dye Transfer Inhibitors.

Optionally, dye transfer inhibitors may also be added to the liquid detergent or cleanser 22. Dye transfer inhibitors include any agent that is capable of preventing redeposition of free dyes onto textile. As a result, textiles keep their original color and whites stay white, even after multiple washes. Preferred levels of dye transfer inhibitors, when present are from about 0.01 to about 0.5 wt. % of the cleansing composition 12.

Useful dye transfer inhibitors include not only the polyvinylpyrrolidones of molecular weights of from about 15,000 to about 50,000 Daltons, but also the polyvinylpyrrolidones having molar weights above about 1,000,000, especially from about 1,500,000 to about 4,000,000, the N-vinylimidazole-N-vinylpyrrolidone copolymers, the polyvinyloxazolidones, the copolymers based on vinyl monomers and carboxamides, the polyesters and polyamides containing pyrrolidone groups, the grafted polyamidoamines and polyethyleneimines, the polymers with amide groups from secondary amines, the polyamine N-oxide polymers, the polyvinyl alcohols, and the copolymers based on acrylamidoalkenylsulfonic acids. However, it is also possible to use enzymatic systems, comprising a peroxidase and hydrogen peroxide or a substance which in water provides hydrogen peroxide. The addition of a mediator compound for the peroxidase, for example, an acetosyringone, a phenol derivative, or a phenothiazine or phenoxazine, is preferred in this case, it being also possible to use abovementioned active polymeric dye transfer inhibitor substances as well. Polyvinylpyrrolidone for use in compositions of the invention preferably has an average molar mass in the range from 10,000 to 60,000, in particular in the range from 25,000 to 50,000. Among the copolymers, preference is given to those of vinylpyrrolidone and vinylimidazole in a molar ratio of 5:1 to 1:1 having an average molar mass in the range from 5,000 to 50,000, in particular from 10,000 to 20,000.

Thickeners (Polymers) and/or Suspending Agents.

Furthermore, the liquid detergent or cleanser 22 may further comprise a suspending agent that may or may not be a thickener, or alternatively a thickener that may or may not be a suspending agent. Use of a suspending agent in the liquid detergent or cleanser 22 helps suspend the soap flakes 20. The suspending agent may comprise a polysaccharide, a cellulosic compound, and/or a thickener. In an exemplary embodiment, the liquid detergent or cleanser 22 comprises a suspending agent present in an amount of from about 0.2 to about 1.5 wt. % of the cleansing composition 12.

The use of thickeners in the liquid detergent or cleanser 22 helps increase the viscosity of the liquid detergent or cleanser 22. The use of thickeners in particular in gel-like liquid laundry detergent compositions will boost consumer acceptance. The thickened consistency of the composition simplifies the application of the compositions directly to the stains to be treated. The kind of run-off familiar from thin liquid compositions is prevented as a result. In an exemplary embodiment, the liquid detergent or cleanser 22 comprises a thickener present an amount of from about 0.2 to about 1.5 wt. % of the cleansing composition 12.

In one example, the thickener comprises Acusol 430, available from Dow Chemical. Other suitable polymers include, but are not limited to, polymers originating in nature such as, agar-agar, carrageen, tragacanth, gum arabic, alginates, pectins, polyoses, guar flour, carob seed flour, starch, dextrins, gelatins and casein.

Modified natural substances originate primarily from the group of modified starches and celluloses, examples which may be mentioned here being carboxymethylcellulose and cellulose ethers, hydroxyethylcellulose and hydroxypropylcellulose, and carob flour ether. A large group of thickeners which is used widely in very diverse fields of application are the completely synthetic polymers, such as polyacrylic and polymethacrylic compounds, vinyl polymers, polycarboxylic acids, polyethers, polyimines, polyamides and polyurethanes.

Thickeners from these classes of substance are commercially widely available and are offered, for example, under the trade names Acusol®-820 (methacrylic acid (stearyl alcohol-20-EO) ester-acrylic acid copolymer, 30% strength in water, Dow Chemical), Polygel, such as Polygel DA (3V Sigma), Carbopol® (B.F. Goodrich), such as Carbopol® 940 (molecular weight approximately 4.000.000), Carbopol® 941 (molecular weight approximately 1,250,000), Carbopol® 934 (molecular weight approximately 3,000,000), Carbopol® ETD 2623, Carbopol® 1382 (INCI Acrylates/C10-30 Alkyl Acrylate Crosspolymer) and Carbopol® Aqua 30, Aculyn® and Acusol® (Dow Chemical), Tego® (Degussa-Goldschmidt), Dapral®-GT-282-S (alkyl polyglycol ether, Akzo), Deuterol®-Polymer-11 (dicarboxylic acid copolymer, Schoner GmbH), Deuteron®-XG (anionic heteropolysaccharide based on .beta.-D-glucose, D-manose, D-glucuronic acid, Schoner GmbH), Deuteron®-XN (nonionogenic polysaccharide, Schoner GmbH), Dicrylan®-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Dow Chemical), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

A particularly useful polymeric polysaccharide thickener is xanthan, a microbial anionic heteropolysaccharide produced by Xanthomonas campestris and other species under aerobic conditions and has a molar mass of from about 2 to about 15 million g/mole. Xanthan is formed from a chain of β-1,4-bound glucose (cellulose) having side chains. The structure of the subgroups consists of glucose, mannose, glucuronic acid, acetate and pyruvate, the number of pyruvate units determining the viscosity of the xanthan.

Crease Control Agents.

The liquid detergent or cleanser 22 may comprise crease control agents. Since textile fabrics, especially those composed of rayon, wool, cotton and blends thereof, may tend to crease because the individual fibers are sensitive to bending, kinking, pressing and squashing transversely to the fiber direction, the compositions may comprise synthetic anticrease agents. Suitable crease control agents include, for example, synthetic products based on fatty acids, fatty acid esters, fatty acid amides, fatty acid alkylolesters, fatty acid alkylolamides or fatty alcohols, which have mostly been reacted with ethylene oxide, or products based on lecithin or modified phosphoric esters.

Pearl Luster Agents.

As well as the aforementioned components, the liquid detergent or cleanser 22 may comprise pearl luster agents. Pearl luster components include any agent which endows textiles with an additional luster.

Examples of useful pearl luster agents include, but are not limited to: alkylene glycol esters; fatty acid alkanolamides; partial glycerides; esters of polybasic carboxylic acids with or without hydroxyl substitution with fatty alcohols having 6 to 22 carbon atoms; fatty materials, for example fatty alcohols, fatty ketones, fatty aldehydes, fatty ethers and fatty carbonates which together have at least 24 carbon atoms; ring-opening products of olefin epoxides having 12 to 22 carbon atoms with fatty alcohols having 12 to 22 carbon atoms, fatty acids and/or polyols having 2 to 15 carbon atoms and 2 to 10 hydroxyl groups and also mixtures thereof.

Fabric Softeners.

In a further exemplary embodiment, the liquid detergent or cleanser 22 comprises a softener component present in an amount up to 15 wt. %, such as from about 0.1 to about 10 wt. %, such as from about 0.5 to about 7 wt. %, for example from about 1 to about 3 wt. % of the cleansing composition 12.

The fabric softening agent may comprise any agent that softens and controls static electricity in fabrics. Examples of fabric-softening components are quaternary ammonium compounds, cationic polymers, and emulsifiers.

Suitable examples are quaternary ammonium compounds of the formulae (I) and (II);

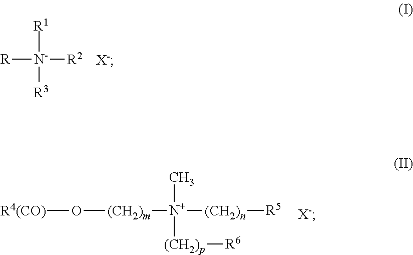

where, in (I), R and R¹ each represent an acyclic alkyl radical of 12 to 24 carbon atoms, R² represents a saturated C₁-C₄-alkyl or hydroxyalkyl radical, R³ is either the same as R, R¹ or R² or represents an aromatic radical. X— represents either a halide, methosulfate, methophosphate or phosphate ion and also mixtures thereof. Examples of cationic compounds of the formula (I) are didecyldimethylammonium chloride, ditallowdimethylammonium chloride or dihexadecylammonium chloride.

Compounds of the formula (II) are known as ester quats. Ester quats are notable for excellent biodegradability. In the formula (II), R⁴ represents an aliphatic alkyl radical of 12 to 22 carbon atoms which has 0, 1, 2 or 3 double bonds; R⁵ represents H, OH or O(CO)R⁷, R⁶ represents H, OH or O(CO)R⁸ independently of R⁵, with R⁷ and R⁸ each being independently an aliphatic alkyl radical of 12 to 22 carbon atoms which has 0, 1, 2 or 3 double bonds. m, n and p are each independently 1, 2 or 3. X— may be either a halide, methosulfate, methophosphate or phosphate ion and also mixtures thereof. Preference is given to compounds where R⁵ is O(CO)R⁷ and R⁴ and R⁷ are alkyl radicals having 16 to 18 carbon atoms. Particular preference is given to compounds wherein R⁶ also represents OH. Examples of compounds of the formula (II) are methyl-N-(2-hydroxyethyl)-N,N-di-(tallowacyloxyethyl)ammonium methosulfate, bis-(palmitoyl)ethylhydroxyethylmethylammonium methosulfate or methyl-N,N-bis(acyloxyethyl)-N-(2-hydroxyethyl)ammonium methosulfate. In quaternized compounds of the formula (II) which comprise unsaturated alkyl chains, preference is given to acyl groups whose corresponding fatty acids have an iodine number between 5 and 80, preferably between 10 and 60 and especially between 15 and 45 and also a cis/trans isomer ratio (in % by weight) of greater than 30:70, preferably greater than 50:50 and especially greater than 70:30. Commercially available examples are the methylhydroxyalkyldialkoyloxyalkylammonium methosulfates marketed by Stepan under the Stepantex® brand or the Cognis products appearing under Dehyquart® or the Goldschmidt-Witco products appearing under Rewoquat®. Preferred compounds further include the diester quats of the formula (III) which are obtainable under the name Rewoquat® W 222 LM or CR 3099 and provide stability and color protection as well as softness. Formula (III) being;

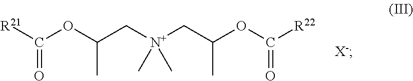

where R²¹ and R²² each independently represent an aliphatic radical of 12 to 22 carbon atoms which has 0, 1, 2 or 3 double bonds.

As well as the quaternary compounds described above it is also possible to use other known compounds, for example quaternary imidazolinium compounds of the formula (IV);

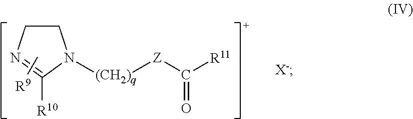

where R⁹ represents H or a saturated alkyl radical having 1 to 4 carbon atoms, R¹⁰ and R¹¹ are each independently an aliphatic, saturated or unsaturated alkyl radical having 12 to 18 carbon atoms, R¹⁰ may alternatively also represent O(CO)R²⁰, R²⁰ being an aliphatic, saturated or unsaturated alkyl radical of 12 to 18 carbon atoms, Z is an NH group or oxygen, X— is an anion and q can assume integral values between 1 and 4.

Useful quaternary compounds are further described by the formula (V);

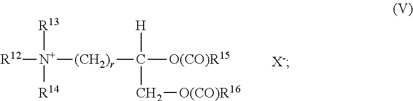

where R¹², R¹³ and R¹⁴ independently represent a C₁₋₄-alkyl, alkenyl or hydroxyalkyl group, R¹⁵ and R¹⁶ each independently represent a C₈₋₂₈-alkyl group and r is a number between 0 and 5.

As well as compounds of the formulae (I) and (II) it is also possible to use short-chain, water-soluble quaternary ammonium compounds, such as trihydroxyethylmethylammonium methosulfate or alkyltrimethylammonium chlorides, dialkyldimethylammonium chlorides and trialkylmethylammonium chlorides, for example cetyltrimethylammonium chloride, stearyltrimethylammonium chloride, distearyldimethylammonium chloride, lauryldimethylammonium chloride, lauryldimethylbenzylammonium chloride and tricetylmethylammonium chloride. Similarly, protonated alkylamine compounds, which have a softening effect, and also the nonquaternized, protonated precursors of cationic emulsifiers are suitable.

Cationic compounds are also useful and include quaternized protein hydrolyzates. Suitable cationic polymers include the polyquaternium polymers, as in the CTFA Cosmetic Ingredient Dictionary (The Cosmetic, Toiletry and Fragrance, Inc. 1997), in particular the polyquaternium-6, polyquaternium-7, polyquaternium-10 polymers (Ucare Polymer IR 400; Amerchol), also referred to as merquats, polyquaternium-4 copolymers, such as graft copolymers with a cellulose backbone and quaternary ammonium groups that are bonded via allyldimethylammonium chloride, cationic cellulose derivatives, such as cationic guar, such as guar hydroxypropyltriammonium chloride, and similar quatemized guar derivatives (e.g., Cosmedia Guar, manufacturer: Cognis GmbH), cationic quaternary sugar derivatives (cationic alkyl polyglucosides), e.g., the commercial product Glucquat® 100, according to CTFA nomenclature a “Lauryl Methyl Gluceth-10 Hydroxypropyl Dimonium Chloride”, copolymers of PVP and dimethylaminomethacrylate, copolymers of vinylimidazole and vinylpyrrolidone, aminosilicone polymers and copolymers.

It is likewise possible to use polyquaternized polymers (e.g., Luviquat Care from BASF) and also cationic biopolymers based on chitin and derivatives thereof, for example the polymer obtainable under the trade name Chitosan® (manufacturer: Cognis). Likewise suitable are cationic silicone oils, such as, for example, the commercially available products Q2-7224 (manufacturer: Dow Corning; a stabilized trimethylsilylamodimethicone), Dow Corning 929 emulsion (comprising a hydroxyl-amino-modified silicone, which is also referred to as amodimethicone), SM-2059 (manufacturer: General Electric), SLM-55067 (manufacturer: Wacker) Abil®-Quat 3270 and 3272 (manufacturer: Goldschmidt-Rewo; diquaternary polydimethylsiloxanes, quatemium-80) and Siliconquat Rewoquat® SQ 1 (Tegopren® 6922, manufacturer: Goldschmidt-Rewo).

It is likewise possible to use compounds of the formula (VI);

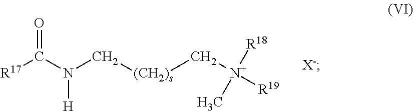

which may be alkylamidoamines in their nonquaternized or, as shown, their quatemized form. R¹⁷ may be an aliphatic alkyl radical having 12 to 22 carbon atoms with 0, 1, 2 or 3 double bonds and can assume values between 0 and 5. R¹⁸ and R¹⁹ are, independently of one another, each H, C₁₋₄-alkyl or hydroxyalkyl. Preferred compounds are fatty acid amidoamines, such as the stearylamidopropyldimethylamine obtainable under the name Tego Amid® S18, or the 3-tallowamidopropyltrimethylammonium methosulfate obtainable under the name Stepantex® X 9124, which are characterized not only by a good conditioning effect, but also by color-transfer-inhibiting effect and in particular by their good biodegradability. Particular preference is given to alkylated quaternary ammonium compounds in which at least one alkyl chain is interrupted by an ester group and/or amido group, in particular N-methyl-N-(2-hydroxyethyl)-N,N-(ditallowacyloxyethyl)ammonium methosulfate and/or N-methyl-N-(2-hydroxyethyl)-N,N-(palmitoyloxyethyl)ammonium methosulfate.

Nonionic softeners are primarily polyoxyalkylene glycerol alkanoates, polybutylenes, long-chain fatty acids, ethoxylated fatty acid ethanolamides, alkyl polyglycosides, in particular sorbitan mono-, di- and triesters, and fatty acid esters of polycarboxylic acids.

In an exemplary embodiment, the liquid detergent or cleanser 22 comprises cationic surfactants. Non-limiting examples of cationic surfactants include alkylated quaternary ammonium compounds where at least one alkyl chain is interrupted by an ester group and/or amido group.

The use of ester quats of the abovementioned formula II will be found particularly advantageous and effective. Especially ester quats of the formula;

[(CH₃)₂N⁺(CH₂CH₂OC(O)—R)₂]X—

Or

[(HOCH₂CH₂)(CH₃)N⁺(CH₂CH₂OC(O)—R)₂]X—

where R=linear saturated or unsaturated alkyl radical of 11 to 19 and preferably 13 to 17 carbon atoms. In an exemplary embodiment, the fatty acid residues are tallow fatty acid residues. X— represents either a halide, for example chloride or bromide, methophosphate or phosphate ion, preferably from methosulfate ion, and also mixtures thereof.

Quaternary ammonium compounds of the aforementioned formula V are further preferable. Specifically, N-methyl-N-(2-hydroxyethyl)-N,N-(ditallowacyloxyethyl)ammonium methosulfate or N-methyl-N-(2-hydroxyethyl)-N,N-(dipalmitoylethyl)ammonium methosulfate are preferred.

In accordance with an exemplary embodiment, a method 100 for making the cleansing product 10 illustrated in FIG. 1 is shown in FIG. 2. With reference to FIG. 2, the method 100 comprises mixing detergent or cleanser ingredients together (step 102) to form a liquid detergent or cleanser. In an exemplary embodiment, the detergent or cleanser ingredients, which includes water and surfactants, such as an anionic surfactant(s) and/or a nonionic surfactant(s), and optionally other additional ingredients as discussed in the foregoing paragraphs, are mixed together at a relatively high shear rate at about room temperature (e.g., 18 to about 25° C.). Soap flakes are dispersed in the liquid detergent or cleanser (step 104) to form a cleansing composition. In an exemplary embodiment, the soap flakes are dispersed in the liquid detergent or cleanser after forming the liquid detergent or cleanser via mixing at a relatively low shear rate at about room temperature to minimize damage to the soap flakes. The cleansing composition is then deposited into a container (step 106).

The following are examples of cleansing products in accordance with various exemplary embodiments. The examples are provided for illustration purposes only and are not meant to limit the various embodiments of the cleansing products in any way. All materials are set forth in weight percent.

### EXAMPLES

### Cleansing Compositions

Cleansing Product—Enzyme Based Formulation (Theoretical Yield)

| Ingredient | Wt. % |
|---|---|
| Water | Balance |
| Anionic Surfactant | 5 to 10 |
| Nonionic Blend | 1 to 5 |
| Fatty Acid | 0.05 to 0.25 |
| Polymer (anti-redeposition) | 0.1 to 1 |
| Optical Brightener | 0.01 to 0.2 |
| Salt | 0.5 to 4 |
| Calcium Chloride | 0.01 to 0.1 |
| Enzyme | 0.25 to 2 |
| Sodium Bicarbonate | 0.1 to 0.5 |
| Sodium Formate | 0.05 to 2 |
| Polysaccharide Blend | 0.2 to 1.5 |
| Soap Flakes | 0.5 to 5 |
| Fragrance | 0 to 0.6 |
| Dye | 0 to 0.01 |
| Preservative | 0.001 to 0.01 |
| Total | 100.0 |

Cleansing Product—Natural Formulation (Theoretical Yield)

| Ingredient | Wt. % |
|---|---|
| Water | Balance |
| Anionic Surfactant | 5 to 10 |
| Nonionic Blend | 1 to 5 |
| Fatty Acid | 0.05 to 0.25 |
| Salt | 0.5 to 4 |
| Polymer (anti-redeposition) | 0.1 to 1 |
| Polysaccharide Blend | 0.2 to 1.5 |
| Sodium Bicarbonate | 0.1 to 0.5 |
| Optical Brightener | 0.01 to 0.2 |
| Soap Flakes | 0.5 to 5 |
| Fragrance | 0 to 0.6 |
| Preservative | 0.001 to 0.01 |
| Total | 100.0 |

Cleansing Product—Non-Enzyme Based Formulation (Theoretical Yield)

| Ingredient | Wt. % |
|---|---|
| Water | Balance |
| Anionic Surfactant | 5 to 10 |
| Nonionic Blend | 1 to 5 |
| Fatty Acid | 0.05 to 0.25 |
| Sodium Carbonate | 1 to 5 |
| Surfactant | 1 to 5 |
| Salt | 0.5 to 4 |
| Polysaccharide Blend | 0.2 to 1.5 |
| Polymer (anti-redeposition) | 0.1 to 1 |
| EDTA | 0.05 to 5 |
| Optical Brightener | 0.01 to 0.2 |
| Soap Flakes | 0.5 to 5 |
| Fragrance | 0 to 0.6 |
| Dye | 0 to 0.01 |
| Preservative | 0.001 to 0.01 |
| Total | 100.0 |

Accordingly, cleansing compositions and products, and methods for making cleansing products have been described. In an exemplary embodiment, a cleansing composition includes a liquid detergent or cleanser. Soap flakes, which may be any shape(s), color(s), or size(s), are dispersed in the liquid detergent or cleanser for aesthetic appeal. The soap flakes are substantially free of any fillers or inert carriers/substrates, containing primarily active soap and optionally other active ingredients to provide a substantially fully functional dispersion in the liquid detergent or cleanser to enhance, for example, cleansing efficacy.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A cleansing composition comprising:
a liquid detergent or cleanser; and
soap flakes dispersed in the liquid detergent or cleanser.

2. The cleansing composition of claim 1, wherein the soap flakes are present in an amount of from about 0.5 to about 5 wt. % of the cleansing composition.

3. The cleansing composition of claim 1, wherein the soap flakes are present in an amount of from about 0.75 to about 2 wt. % of the cleansing composition.

4. The cleansing composition of claim 1, wherein the soap flakes comprise sodium stearate.

5. The cleansing composition of claim 1, wherein the liquid detergent or cleanser is translucent or clear.

6. The cleansing composition of claim 1, wherein the liquid detergent or cleanser comprises water and surfactants that include an anionic surfactant, a nonionic surfactant, or a combination thereof.

7. The cleansing composition of claim 6, wherein liquid detergent or cleanser comprises the anionic surfactant present in an amount of from about 5 to about 10 wt. % of the cleansing composition.

8. The cleansing composition of claim 6, wherein the liquid detergent or cleanser comprises the nonionic surfactant present in an amount of from about 1 to about 5 wt. % of the cleansing composition.

9. The cleansing composition of claim 1, wherein the liquid detergent or cleanser comprises a suspending agent.

10. The cleansing composition of claim 9, wherein the suspending agent comprises polysaccharide, a cellulosic compound, a thickener, or combinations thereof.

11. The cleansing composition of claim 10, wherein the liquid detergent or cleanser comprises the suspending agent present in an amount of from about 0.2 to about 1.5 wt. % of the cleansing composition.

12. The cleansing composition of claim 1, wherein the soap flakes have a size, shape, color, or combination thereof such that the soap flakes are visibly discernible from the liquid detergent or cleanser.

13. A cleansing product comprising:
a container; and
a cleansing composition housed within the container and comprising:
a liquid detergent or cleanser; and
soap flakes dispersed in the liquid detergent or cleanser.

14. The cleansing product of claim 13, wherein the liquid detergent or cleanser is a liquid laundry detergent.

15. The cleansing product of claim 13, wherein the liquid detergent or cleanser is a liquid body wash.

16. The cleansing product of claim 13, wherein the liquid detergent or cleanser is a liquid hand wash.

17. A method for making a cleansing product, the method comprising the steps of:
mixing detergent or cleanser ingredients together to form a liquid detergent or cleanser;
dispersing soap flakes in the liquid detergent or cleanser to form a cleansing composition; and
depositing the cleansing composition into a container.

18. The method of claim 17, wherein the step of dispersing comprises mixing the soap flakes in the liquid detergent or cleanser at a lower mixing rate than mixing the detergent or cleanser ingredients together to form the liquid detergent or cleanser.

19. The method of claim 17, wherein the step of mixing comprises combining water and surfactants that includes an anionic surfactant, a nonionic surfactant, or a combination thereof.

20. The method of claim 17, wherein the step of dispersing comprises forming the cleansing composition having the soap flakes present in an amount of from about 0.5 to about 5 wt. % of the cleansing composition.
